(19) United States
(12) Patent Application Publication
(10) Pub. No.: US 2008/0267843 A1
(43) Pub. Date: Oct. 30, 2008

(54) Spinning Disc Reactor with Spiral Passageway for Heat Transfer Fluid

(76) Inventors: John Robert Burns, Sunderland (GB); Ian Henderson, Middlesbrough (GB)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 11/572,440

(22) PCT Filed: Jul. 18, 2005
(86) PCT No.: PCT/GB05/02812

§ 371 Date: Jan. 22, 2007

(30) Foreign Application Priority Data
Jul. 20, 2004 (GB) 04161949

(51) Int. Cl. B01J 19/00

(52) U.S. Cl. 422/198

(57) ABSTRACT

There is disclosed a reactor apparatus including a support element that is rotatable about an axis and which has a first surface generally centered on the axis. The first surface is adapted for outward radial flow of a thin film of fluid phase reactant thereacross when supplied thereto as the support element is rotated. The support element also has a second surface opposed to the first surface and which is in thermal communication with the first surface. The second surface is provided with a spiral passageway generally centered on the axis and also with means for supplying a heat transfer fluid to the spiral passageway. By providing a spiral passageway for the heat transfer fluid, improved heat transfer from the first surface to the heat transfer fluid is obtained.

The present invention relates to a rotating surface of revolution reactor or spinning disc reactor for mass and heat transfer applications, and in particular to such a reactor provided with a spiral passageway on a reverse surface thereof through which heat transfer fluid may be supplied.

Rotating reactors or spinning disc reactors (SDRs) for mass and heat transfer applications are known from the present applicant's International patent applications WO00/48731, WO00/48729, WO00/48732, WO00/48730 and WO00/48728, the full contents of which are hereby incorporated into the present application by reference. Rotating reactors generally comprise a rotating or spinning surface, for example a disc or a cone, onto which one or more fluid reactants are supplied. Centrifugal forces cause the reactants to pass outwardly across the surface (i.e. centrifugal acceleration is aligned with a surface radius vector) in the form of a thin, generally wavy film, the film then being thrown from a circumference of the surface for collection. High turbulence and shear stresses in the film cause excellent mixing and mass transfer, and the low thickness of the film allows for excellent heat transfer to and from the film. It is to be appreciated that the generation of a thin, generally wavy and radially outwardly-moving film of reactant on the spinning surface is a key feature of SDR technology, including the present invention. Generally, high speeds of rotation are preferred, for example over 50 rpm and in some applications over 500 rpm and even over 2000 rpm and higher.

An important requirement for an SDR when performing endothermic or exothermic reactions is the maintenance of a substantially uniform surface temperature over all or at least a wide range of operating conditions. In order to achieve this, it is essential to provide excellent heat transfer to or from the reactants on the surface of the SDR. One way of providing good heat transfer is to apply a heat transfer fluid to a side of the surface that is opposed to that across which the reactants pass, for example as described more fully in WO 00/48732, in which the heat transfer fluid passes radially across the underside of the SDR surface in a manner analogous to the flow of the reactants on the upper surface. It will be appreciated that heat transfer is thus between the heat transfer fluid and the thin film of reactants across the two opposed surfaces of the SDR. Since the film is thin and highly agitated, it rarely limits the heat transfer. However, a significant limitation may be encountered with heat transfer between the surfaces of the SDR (which is generally made of a conductive metal), and also from the opposed surface of the SDR to the heat transfer fluid.

Spinning disc reactor technology allows for the generation of thin films of sub-millimetre scale and for low viscosity liquids scales even as low as tens of microns. This provides an environment for rapid heat transfer through the film typically giving heat fluxes for the films on top of the spinning disc in the region of tens of kWm⁻²K⁻¹. In order to realise the potential of this technology, heat transfer performance on the underside of the disc must be capable of reaching similar orders of magnitude.

To achieve this goal heat transfer performance through both the disc material and the heat transfer fluid below the disc must ideally reach at least the level of several kWm⁻²K⁻¹. One mechanism to achieve this is the use of highly conductive materials for the disc surface, such as copper, that can cope with this level of heat transfer even over a thickness of several millimetres. However, this can only improve heat transfer by a certain degree.

According to the present invention, there is provided a reactor apparatus including a support element that is rotatable about an axis and has a first surface generally centered on the axis, the first surface being adapted for outward radial flow of a thin film of fluid phase reactant thereacross when supplied thereto as the support element is rotated, and a second surface opposed to the first surface and in thermal communication with the first surface, wherein the second surface is provided with a spiral passageway generally centered on the axis and means for supplying a heat transfer fluid to the spiral passageway.

The support element may be generally disc shaped, with the first surface being uppermost and the axis of rotation generally vertical. However, in some embodiments the axis of rotation may be horizontal or tilted, with the support element then being angled accordingly.

The first surface may be generally flat, or may be concave or convex or conical in some embodiments. Where the first surface is concave or convex (or conical), it is preferred that the second surface will have a corresponding configuration, since it is desirable for the first and second surfaces to be generally parallel to each other and in good thermal communication.

In a particularly preferred embodiment, the support element is formed as a short, wide cylinder. A base of the cylinder may be formed as a circular tray with a circumferential wall. At least one spiral wall is provided on the tray extending from a centre of the tray towards the circumferential wall, the spiral wall defining the spiral passageway. A lid is then affixed onto the base of the cylinder so as to seal the support element, an upper surface of the lid forming the first surface and a lower surface of the lid forming the second surface. The lower surface of the lid is preferably secured so as to be in good thermal communication with the spiral wall or element. At least the lid and the spiral wall are made of a thermally conductive material, for example a metal. An inlet and an outlet are provided so as to allow ingress and egress of a heat transfer fluid to and from the support element, the heat transfer fluid flowing through the spiral passageway when the support element is rotated. In this way, the heat transfer fluid can transfer heat to or from the first surface by way of conduction (and convection, since the heat transfer fluid flows through the passageway). Heat is conducted to or from the first surface by way of conduction through the lid to the second surface, and then both directly into the heat transfer fluid from the second surface, and also by way of conduction from the second surface through the spiral wall and thence to or from the heat transfer fluid.

It will be appreciated that in embodiments where the lid is concave, convex or, in extreme cases, conical, the spiral wall and the base of the cylinder will have to be configured appropriately so as to define the required spiral passageway. These modifications will be apparent to a person of ordinary skill in the art.

Where only one spiral wall is provided, the ingress may be through the base of the cylinder at a central location, and the corresponding egress may be at a peripheral part of the base of the cylinder, or vice versa. The heat transfer fluid may be pumped through the spiral passageway as required.

In a particularly preferred embodiment, the spiral wall is configured as a double spiral having two peripheral starts, which may be diametrically opposed to each other, thus forming a double concentric spiral passageway. In other words, the spiral passageway comprises a pair of interleaved first and second spiral passageways, with the ingress being located centrally and opening into the first spiral passageway, and the egress also being located centrally and opening into the second spiral passageway. Heat transfer fluid supplied to the ingress thus flows outwardly through the first spiral passageway towards the circumferential wall, and then passes at the circumferential periphery into the start of the second spiral passageway and back towards the egress at the centre. Thus, the flows of heat transfer fluid in adjacent turns of the spiral passageway are countercurrent. This close juxtaposition of outward and inward flows of heat transfer fluid can help to ensure that any temperature difference between central and peripheral parts of the first surface is significantly reduced. It is possible that where initial flow outward towards the circumferential wall is against the direction of rotation of the support element and subsequent return flow inward towards the centre is with the direction of rotation, a Coriolis force acting on the heat transfer fluid will be in a direction of the flow, thus assisting in passage of the heat transfer fluid through the spiral passageway.

The heat transfer fluid may be supplied to the ingress and removed from the egress by way of a rotary shaft on which the support element is mounted and which is used to rotate the support element. The rotary shaft may include two side-by-side pipes for the heat transfer fluid, or may have a coaxial pipe-within-pipe arrangement. The heat transfer fluid may be pumped through the reactor from a controlled temperature bath using a connection to a base of the shaft, for example a rotary union.

As previously indicated, heat transfer from or to the thin film of radially flowing reactant on the first surface is to or from the heat transfer fluid flowing in the spiral passageway from the temperature controlled bath. This enables the temperature of the reactant to be closely controlled. The spiral wall provides an additional fin surface for heat transfer.

A further advantage provided by the spiral wall is to ensure mechanical strength and rigidity. It will be appreciated that the lid having the first and second surfaces should be as thin as possible so as to ensure good heat transfer. However, a very thin lid will not have good structural strength, and may bow or distort due to centrifugal forces as the support element is rotated, and also due to pressure differentials if the heat transfer fluid is running at high pressure through the spiral passageway. This is especially true if the support element as a whole is operating inside an evacuated housing. By bonding the lid to the turns of the spiral wall, the lid is mechanically supported at a large number of points. This bonding also helps to ensure good thermal contact between the second surface and the spiral wall.

Although it is usually desirable for there to be heat transfer between the outward and inward flows of heat transfer fluid across the spiral wall, it is sometimes preferable for this heat transfer to be reduced, for example in applications where good heat recovery from the heat transfer fluid is required. Accordingly, in a further embodiment of the present invention, a layer of insulating material may be provided on one or both sides of the spiral wall. Generally, it is preferred that the layer of insulating material is provided on only one side of the spiral wall, leaving the other side of the spiral wall free to act as a fin surface for heat transfer to or from the heat transfer fluid. The layer of insulating material may be bonded to the spiral wall, or may be spring loaded against the spiral wall.

Another feature optionally provided by the present invention to improve heat transfer is the provision of a secondary spiral fin element on the second surface, this spiral fin element being thermally conductive and complementary to the spiral passageway so as to mesh therewith. The spiral fin element does not extend all the way to the base of the cylinder, but stops short thereof. In this way, the spiral passageway is provided with a fin that extends thereinto from the second surface, thus providing a heat transfer surface additional to the second surface itself and the spiral wall. Because the secondary spiral fin element is not required to provide mechanical strength, it can be made out of a relatively soft, highly conductive material such as copper or chromium, with the spiral wall and base of the cylinder, for example, being made out of stainless steel or other material that is less thermally conductive but has superior strength. Alternatively, the entire apparatus may be made of copper or chromium, or of stainless steel or other materials. A thermal conductivity of at least 100 Wm⁻¹K⁻¹ is preferred for the parts of the reactor that serve as heat transfer surfaces or elements.

Indeed, it is to be appreciated that different parts of the reactor of the present invention may be made of different materials depending on structural requirements and heat transfer requirements.

The spiral passageway may have a substantially constant cross-sectional area throughout, or may have a cross-sectional area that varies in size and/or shape so as to provide variations in the velocity of the heat transfer fluid at different points. This can allow a particular heat transfer performance profile to be maintained across the first surface, for example a higher heat transfer rate at the centre of the first surface and a lower heat transfer rate at the edge, or vice versa. In some embodiments, a higher or lower heat transfer rate annulus (or several such annuli) may be defined intermediate the centre and the edge, thus providing a custom heat transfer profile for particular reactions. The cross-sectional area of the spiral passageway can be varied by varying the spacing between adjacent turns of the spiral, or by varying the depth of the spiral passageway.

It is to be appreciated that the present invention need not be limited to a single or double spiral passageway, but may extend to a triple or higher spiral passageway.

For a better understanding of the present invention and to show how it may be carried into effect, reference shall now be made by way of example to the accompanying drawings, in which:

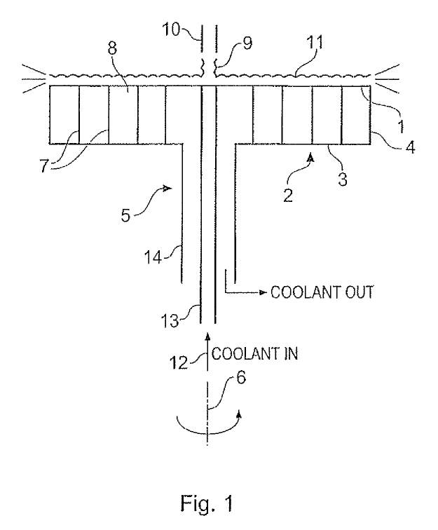

FIG. 1 shows a schematic cross-section through an embodiment of the present invention;

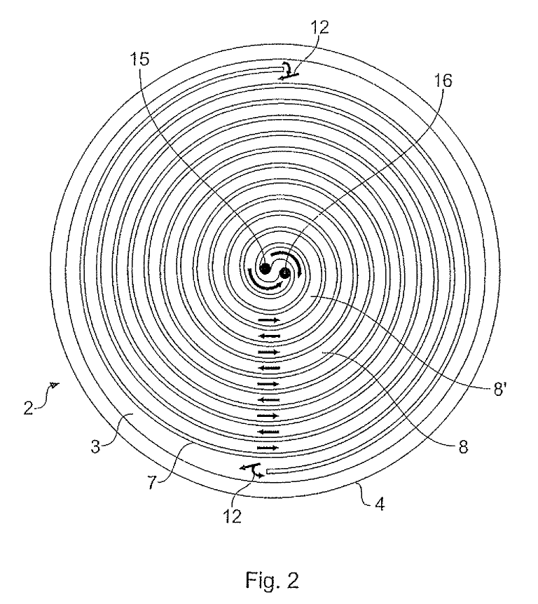

FIG. 2 shows a plan view of a base cylinder of a reactor of the present invention showing a spiral passageway;

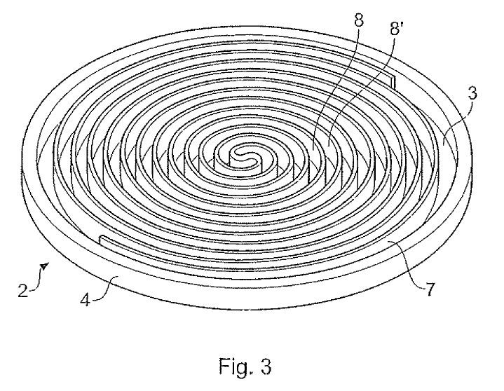

FIG. 3 is a perspective view of the base cylinder of FIG. 2;

FIG. 4 is a plan view the base cylinder of FIGS. 2 and 3 further provided with an insulating material in the spiral passageway;

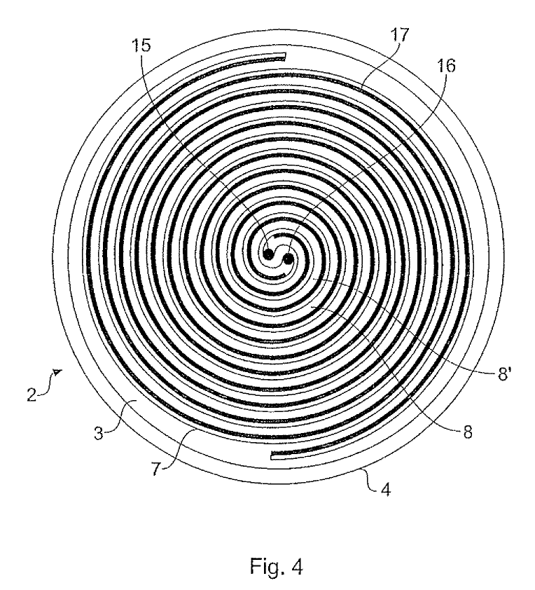

FIG. 5 shows the insulating material being inserted into the base cylinder of FIG. 4;

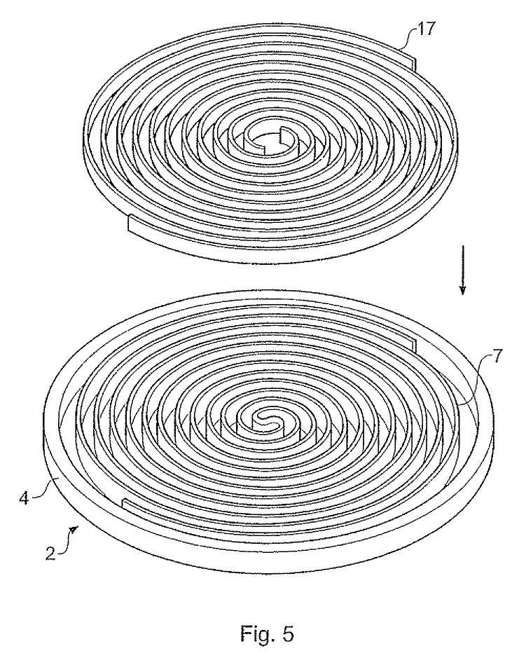

FIG. 6 is a perspective view of the base cylinder of FIG. 4;

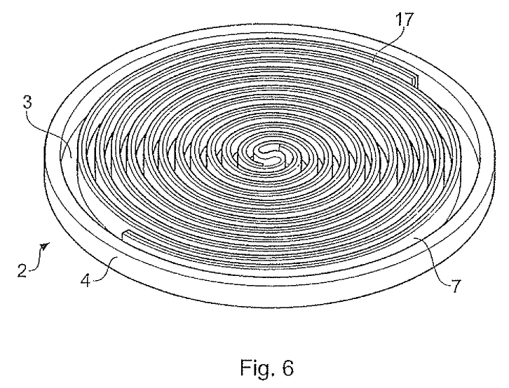

FIG. 7 is a horizontal cross-section through a base cylinder with a spiral passageway further provided with spiral heat transfer fins;

FIG. 8 shows the base cylinder of FIG. 7 in perspective view, together with an upper lid bearing the spiral heat transfer fins;

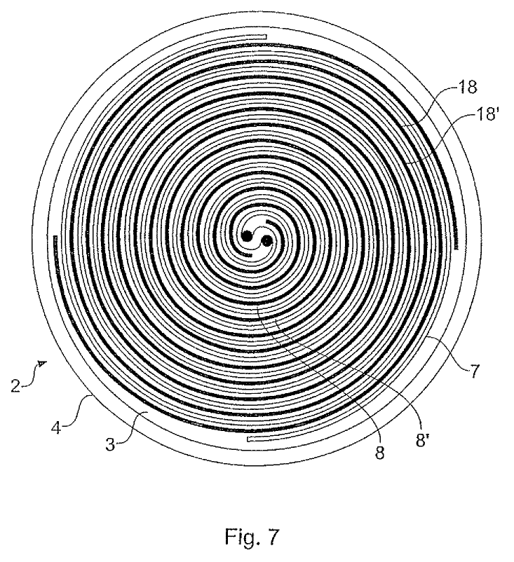

FIG. 9 is a radial cross-section through a part of the assembly of FIG. 8; and

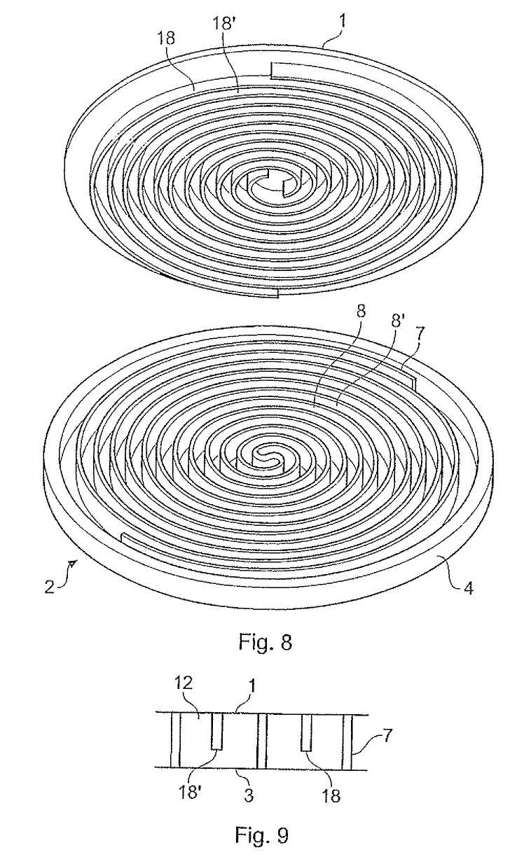

FIGS. 10, 11 and 12 show alternative arrangements for the spiral passageway.

FIG. 1 shows a vertical cross-section through a reactor apparatus of the present invention comprising a thin circular metal lid 1 affixed over a base cylinder 2 with a circular tray 3 and circumferential wall 4. The base cylinder 2 is centrally mounted on a double pipe shaft 5 which also served as a rotary shaft by way of which the base cylinder can be rotated at high speed about an axis 6. Internal walls 7 define a spiral passageway 8 inside the base cylinder 2 as will be described in more detail hereinbelow. A fluid reactant 9 is supplied to a central part of an external face of the lid 1 by way of a feed 10, and then passes radially across the lid 1 as a thin wavy film 11 by way of centrifugal forces when the base cylinder 2 is rotated at high speed. The reactant 9 is then thrown from the periphery of the lid 1 and may be collected by collection means (not shown). A heat transfer fluid 12 is pumped into the spiral passageway 8 up a central pipe 13 of the shaft 5, passes through the spiral passageway 8 to a periphery of the base cylinder 2, and then back through an interleaved part of the spiral passageway 8 towards the centre of the base cylinder 2, from where it passes down a peripheral pipe 14 of the shaft 5. The heat transfer fluid 12 serves to transfer heat from or to the thin wavy film 11 of the reactant 9.

FIGS. 2 and 3 show the base cylinder 2 of FIG. 1 in plan and perspective view respectively, with the spiral passageway 8 and the internal walls 7 more clearly visible. It can be seen that in this embodiment, the internal walls 7 are in fact a single continuous internal wall 7 formed as a double spiral and defining a first spiral passageway 8 for outward flow of the heat transfer fluid 12 from a central ingress 15, and a second spiral passageway 8′ for inward flow of the heat transfer fluid 12 from a periphery of the base cylinder 2 to a central egress 16. The two spiral passageways 8 and 8′ are interleaved, with opposing flow in adjacent passageways. The ingress 15 and egress 16 are formed as holes in the circular tray 3 and connect respectively to the central pipe 13 and the peripheral pipe 14.

The circumferential wall 4 in this embodiment is significantly thicker than the internal wall 7. This is because the circumferential wall 4, together with the circular tray 3, is designed so as to provide mechanical strength and rigidity to the reactor, and may be made out of stainless steel or the like. The internal wall 7, and also the lid 1, can be made out of a softer material with higher thermal conductivity, for example copper or chromium, and can be made thinner. This is because the internal wall 7 and the lid 1 are designed to provide excellent heat transfer performance, and are not used as significant load bearing members. Nevertheless, by bonding the underside of the lid 1 to the top of the internal wall 7, not only is good thermal conductivity assured, but the whole structure also acquires excellent rigidity by way of the lid 1 being supported across most of its area. This means that very high heat transfer fluid pressures can be withstood, which is of particular benefit when the reactor is operating in a vacuum, for example in an evacuated chamber, and/or at very high rotational speeds.

FIGS. 4 and 6 show a modification to the embodiments of FIGS. 2 to 4, in which a layer of insulating material 17 is provided on inwardly-facing sides of the internal wall 7. The insulating material 17 may be formed as a pair of spirals of low thermal conductivity material (e.g. a plastics material, which may have a foamed structure for improved insulating properties) having the same general profile as the inwardly-facing sides of the internal wall 7. The insulating material 17 may be bonded to the inwardly-facing sides of the internal wall 7 by way of suitable adhesives. In a particularly preferred embodiment the insulating material 17 can be made so that it is resilient or springy, thus having properties of a coil spring. When suitably wound and inserted into the spiral passageway 8, as shown in FIG. 5, the insulating material 17 will try to uncoil and will therefore press itself against the internal wall 7 with no need for bonding. Alternatively, the insulating material 17 may be fitted in the manner of a tyre for a train wheel, for example by heating the base cylinder so that it expands slightly, fitting the insulating material 17, and then allowing the base cylinder 2 to contract again through cooling. It will be appreciated that the insulating material 17 may alternatively be located on outwardly-facing sides of the internal wall 7, but this is less preferred since centrifugal forces upon rotation of the reactor will tend to pull the insulating material 17 away from the internal wall 7.

The insulating material 17 helps to reduce heat transfer between adjacent paths of the spiral passageway 8, while still maintaining efficient heat transfer between the lid 1 and the heat transfer fluid 12 by way of the outwardly-facing sides of the internal wall 7. In some applications, such as those requiring heat recovery, there can be a relatively high temperature differential between the heat transfer fluid 12 moving outwardly from the centre and that moving inwardly towards the centre. This can result in significant heat transfer potential through the conductive internal wall 7, thus reducing the efficiency of the reactor for heat recovery. It may therefore not be desirable for there to be heat transfer between these two flows. For the same reason, it may be desirable for the central pipe 13 and peripheral pipe 14 of the shaft 5 to be thermally insulated from each other.

FIGS. 7, 8 and 9 show another variation in which the lid 1 is provided on its underside with a pair of spiral fins 18, 18′ made out of a thermally conductive material. The spiral fins 18, 18′ may advantageously be made of the same material as that of the internal wall 7 and are configured so as to be in good thermal contact with the underside of the lid 1. The spiral fins 18, 18′ are dimensioned so as to mesh into the spiral passageways 8, 8′, but do not extend all the way down to the circular tray 3 (see FIG. 9), thereby allowing flow of heat transfer fluid 12 through the spiral passageways 8, 8′ to be relatively unimpeded. The spiral fins 18, 18′ provide a surface for heat transfer to or from the lid 1 that is additional to that provided by the internal wall 7. An insulating material 17 (not shown in FIGS. 7 to 9) may additionally be provided, for example in the same manner as shown in FIGS. 4 to 6.

FIG. 10 shows in detail an arrangement of the internal wall 7 and the ingress 15 and egress 16, in which the arrangement in generally symmetrical about the axis 6. This arrangement is particularly useful where the shaft 5 includes a pair of side-by-side pipes for flow of heat transfer fluid 12.

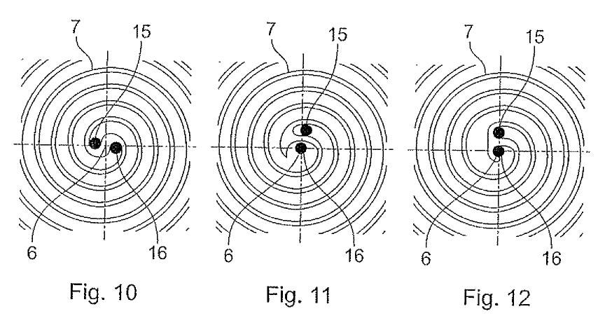

FIGS. 11 and 12 show in detail two alternative arrangements in which the one of the ingress 15 and the egress 16 is located centrally on the axis 6, and in which the other is located slightly off the axis 6. These arrangements are particularly useful when the shaft 5 includes central and peripheral pipes 13, 14.

### EXAMPLE

A reactor of the present invention has been constructed with a diameter of 30 cm and an internal wall 7 made of copper arranged in a double spiral configuration as shown in the drawings. The internal wall 7 has a height of 10 mm and a thickness of 2 mm, and is configured such that the spiral passageways 8, 8′ have a width of 10 mm. The lid 1 is made of copper and has a thickness of 5 mm. Using water as a heat transfer fluid 12, pumped at 300 ml/s with an inlet temperature of 60° C., it has been found that an overall heat transfer performance of approximately 9.7 kWm⁻²K⁻¹ is achieved when used in conjunction with a duty of heating 15 ml/s of water flowing over the upper side of the lid 1. In the example, the reactor was operated at a speed of 650 rpm, but the speed of rotation is not critical to heat transfer performance.

The preferred features of the invention are applicable to all aspects of the invention and may be used in any possible combination.

Throughout the description and claims of this specification, the words “comprise” and “contain” and variations of the words, for example “comprising” and “comprises”, mean “including but not limited to”, and are not intended to (and do not) exclude other components, integers, moieties, additives or steps.

1. A reactor apparatus including a support element that is rotatable about an axis and has a first surface generally centered on the axis, the first surface being adapted for outward radial flow of a thin film of fluid phase reactant thereacross when supplied thereto as the support element is rotated, and a second surface opposed to the first surface and in thermal communication with the first surface, wherein the second surface is provided with a spiral passageway generally centered on the axis and means for supplying a heat transfer fluid to the spiral passageway.

2. A reactor as claimed in claim 1, wherein the support element has a circular periphery.

3. A reactor as claimed in claim 1, wherein the first surface is substantially flat.

4. A reactor as claimed in claim 1, wherein the first surface is convex or concave.

5. A reactor as claimed in claim 4, wherein the first surface is a cone.

6. A reactor as claimed in claim 2, wherein the support element is formed as a circular tray with a circumferential wall.

7. A reactor as claimed in claim 6, wherein the first surface and the second surface are formed as opposing surfaces of a circular lid adapted for connection to the circumferential wall.

8. A reactor as claimed in claim 1, wherein the spiral passageway is a single spiral passageway.

9. A reactor as claimed in claim 1, wherein the spiral passageway is a double spiral passageway.

10. A reactor as claimed in claim 1, wherein the spiral passageway is a triple or greater spiral passageway.

11. A reactor as claimed in claim 1, wherein the spiral passageway is formed by way of at least one thermally conductive spiral wall.

12. A reactor as claimed in claim 11, wherein the spiral wall is in thermal communication with the second surface.

13. A reactor as claimed in claim 6, wherein the spiral wall connects the second surface and the circular tray so as to form the spiral passageway.

14. A reactor as claimed in claim 11, wherein the spiral wall is provided with a layer of insulating material on one side thereof so as thermally to insulate adjacent turns of the spiral passageway from each other.

15. A reactor as claimed in claim 11, wherein the second surface is additionally provided with at least one thermally conductive spiral fin element that projects into the spiral passageway.

16. A reactor as claimed in claim 1, wherein the spiral passageway has a substantially constant cross-sectional area throughout.

17. A reactor as claimed in claim 1, wherein the spiral passageway has a cross-sectional area that varies along its length.

18. A reactor as claimed in claim 9, wherein the spiral passageway is configured so as to define a flowpath for the heat transfer fluid that firstly runs outwardly from the axis and then returns inwardly towards the axis.

19. A reactor as claimed in claim 1, wherein the support element is mounted on a rotatable shaft defining the axis, and wherein the shaft includes a first pipe for ingress of the heat transfer fluid into the spiral passageway and a second pipe for egress of the heat transfer fluid from the spiral passageway.

20. A reactor as claimed in claim 19, wherein the heat transfer fluid is pumped through the first pipe from a reservoir of heat transfer fluid, through the spiral passageway, and then back to the reservoir by way of the second pipe.

21. A reactor as claimed in claim 20, wherein the reservoir of heat transfer fluid includes means for maintaining the heat transfer fluid at a substantially constant temperature.

22. A reactor as claimed in claim 1, wherein at least those parts of the reactor defining the first and second surfaces and the spiral passageway and, where provided a spiral fin element, are made out of a material with a thermal conductivity of at least 100 Wm⁻¹K⁻¹.

23. A reactor as claimed in claim 22, wherein the material is copper or chromium.

24. (canceled)
